(19) United States
(12) Patent Application Publication
(10) Pub. No.: US 2025/0170883 A1
(43) Pub. Date: May 29, 2025

(54) A VEHICLE

(71) Applicant: PROTEAN ELECTRIC LIMITED, FARNHAM, SURREY (GB)

(72) Inventors: Richard FORD, Farnham, Surrey (GB); Jonathan AMEYE, FARNHAM, SURREY (GB)

(21) Appl. No.: 18/841,557

(22) PCT Filed: Aug. 8, 2022
(86) PCT No.: PCT/IB2022/057367

§ 371 Date: Aug. 26, 2024

(30) Foreign Application Priority Data
Aug. 12, 2021 (GB) 2111601.7

(51) Int. Cl. B60K 7/00; B60K 1/02; B62D 21/15

(52) U.S. Cl. CPC B60K 7/0007; B60K 1/02; B62D 21/152

(57) ABSTRACT

A vehicle having a passenger compartment and a crumple zone, wherein the crumple zone has reduced impact resistance relative to the passenger compartment and is positioned forward of the passenger compartment, further comprising a first wheel arranged to be driven by a first drive source having a first axis of rotation for rotating the first wheel and a second wheel arranged to be driven by a second drive source having a second axis of rotation for rotating the second wheel, wherein the first wheel and the second wheel are transversely located on the vehicle relative to each other, wherein the first axis of the first drive source and the second axis of the second drive source are positioned between the front and rear of the crumple zone.

### RELATED APPLICATION

This application is based on prior filed copending International Application No. PCT/IB2022/057367 filed Aug. 8, 2022, which claims priority to Great Britain Application No. 2111601.7, filed Aug. 12, 2021, the entire subject matter of these applications is incorporated herein by reference in its entirety.

### TECHNICAL FIELD

The present invention relates to a vehicle, in particular the mounting of in-wheel electric motors to a vehicle.

### BACKGROUND

To comply with safety requirements, automobiles will typically include one or more structural safety features, commonly known as a crumple or crash zone, which are designed, upon impact of the automobile, to spread the total force imparted on occupants of the automobile over a longer period of time, thereby reducing the peak force imparted on the occupants and reducing the likelihood of injury.

Typically crumple zones are located in the front and/or the rear of a vehicle for the purposes of absorbing the impact of a head-on collision and/or a rear impact.

Consequently, crumple zones provide better protection for occupants of a vehicle against injury compared to vehicles without one or more crumple zones.

For a crumple zone to perform this function, it is necessary for the crumple zone to provide controlled weakening of outer parts of the vehicle, while the inner parts of the vehicle, which the drive train and occupants of the vehicle inhabit, has increased strength and rigidity.

Consequently, the separation of outer parts of the vehicle, for providing controlled weakening, and the inner parts of the vehicle can compromise the space available to occupants of the vehicle.

It is desirable to improve this situation.

### SUMMARY

In accordance with an aspect of the present invention there is provided a vehicle according to the accompanying claims.

The invention as claimed has the advantage of allowing the space available to occupants of a vehicle to increase relative to the space available for crumple zones used within the vehicle.

### BRIEF DESCRIPTION OF THE DRAWINGS

The present invention will now be described, by way of example, with reference to the accompanying drawings, in which:

FIG. 1 illustrates a vehicle according to an embodiment of the present invention;

FIG. 2 illustrates an exploded view of an electric motor as used in an embodiment of the present invention;

FIG. 3 illustrates an exploded view of the electric motor shown in FIG. 1 from an alternative angle.

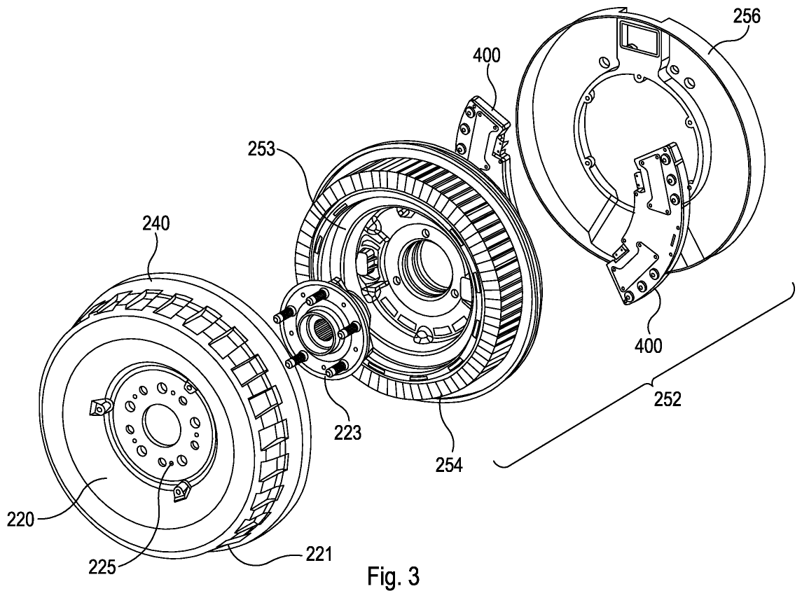

### DETAILED DESCRIPTION

The embodiment of the invention described is for a vehicle having a passenger compartment and one or more crumple zones. The crumple zone has reduced impact resistance relative to the passenger compartment and, for the purposes of one embodiment, positioned forward of the passenger compartment. The vehicle has a first wheel arranged to be driven by a first drive source having a first axis of rotation for rotating the first wheel and a second wheel arranged to be driven by a second drive source having a second axis of rotation for rotating the second wheel. The first wheel and the second wheel are transversely located on the vehicle relative to each other with the first axis of the first drive source and the second axis of the second drive source being longitudinally positioned between the front and rear of the crumple zone with the first drive source and the second drive source being arranged to provide drive to the vehicle. Additionally, or alternatively, the crumple zone may be positioned rear of the passenger compartment.

Preferably, the first and/or second drive source is an in-wheel electric motor.

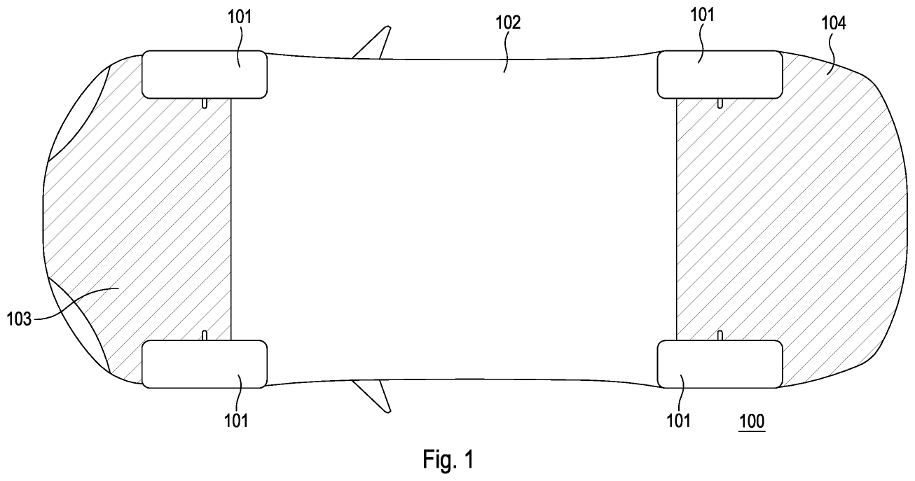

FIG. 1 illustrates a vehicle 100 according to an embodiment of the present invention. The vehicle 100, for example a car or lorry, includes four wheels 101, where two wheels are located in the vehicles forward position in a near side and off side position respectively. Similarly, two additional wheels are located in the vehicles aft position in near side and off side positions respectively, as is typical for a conventional car configuration. However, as would be appreciated by a person skilled in the art, the vehicle may have any number of wheels.

Additionally, the vehicle 100 includes a safety zone 102, which includes a passenger compartment, and a first crumple zone 103 positioned longitudinally forward of the safety zone and a second crumple zone 104 positioned longitudinally to the rear of the safety zone 102. Although the present embodiment describes the vehicle as having two crumple zones positioned to the front and rear of the safety zone 102, respectively, the vehicle may have only one crumple zone positioned to either the front or rear of the safety zone 102.

The first and second crumple zones are arranged, upon impact by the vehicle with an object, to spread the total force imparted to occupants of the vehicle situated in the safety zone 102, over a longer period of time.

Relative to the first and second crumple zones, the safety zone 102 forms a rigid non-deformable compartment for housing occupants of the vehicle.

The drive source for the vehicle is provided by in-wheel electric motors, where an in-wheel electric motor is incorporated within each of the wheels 101. Although the current embodiment describes the vehicle 100 having in-wheel electric motors associated with each of the wheels 101, as would be appreciated by a person skilled in the art, other configurations may be adopted. For example, in-wheel electric motors can be located in just the front two wheels or the rear two wheels. Additionally, although the present embodiment describes the use of in-wheel electric motors, other drive sources can be used, for example axially mounted electric motors.

The respective in-wheel electric motors are mounted to the vehicle such that the axis of each of the in-wheel electric motors are positioned between a front and rear of a respective crumple zone, as illustrated in FIG. 1, thereby removing the need for the drive train for the vehicle to be formed within the safety zone of the vehicle.

The respective in-wheel electric motors may be mounted to the vehicle by any suitable means, for example, via a wheel bearing, as described below.

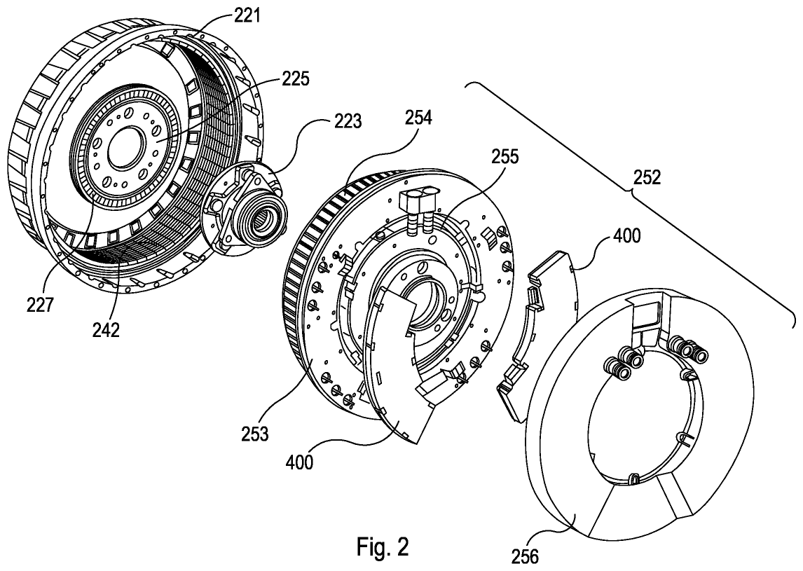

For the purposes of the present embodiment, in a preferred embodiment, as illustrated in FIG. 2, the respective in-wheel electric motors includes a stator 252 comprising a heat sink 253, multiple coils 254 and an electronics module 255 mounted in a rear portion of the stator for driving the coils. The coils 254 are formed on stator tooth laminations to form coil windings, as described below. A stator cover 256 is mounted on the rear portion of the stator 252, enclosing the electronics module 255 to form the stator 252, which may then be fixed to a vehicle and does not rotate relative to the vehicle during use.

The electronics module 255 includes two control devices 400, where each control device 400 includes two inverters and control logic, which in the present embodiment includes a processor, for controlling the operation of both inverters. Although in the present embodiment the electronics module 255 includes two control devices, equally the electronics module 255 may include a single control device or more than two control devices.

A rotor 240 comprises a front portion 220 and a cylindrical portion 221 forming a cover, which substantially surrounds the stator 252. The rotor includes a plurality of permanent magnets 242 arranged around the inside of the cylindrical portion 221. For the purposes of the present embodiment 32 magnet pairs are mounted on the inside of the cylindrical portion 221. However, any number of magnet pairs may be used.

The magnets are in close proximity to the coil windings on the stator 252 so that magnetic fields generated by the coils interact with the magnets 242 arranged around the inside of the cylindrical portion 221 of the rotor 240 to cause the rotor 240 to rotate. As the permanent magnets 242 are utilized to generate a drive torque for driving the electric motor, the permanent magnets are typically called drive magnets.

The rotor 240 is attached to the stator 252 by a bearing block 223. The bearing block 223 can be a standard bearing block as would be used in a vehicle to which this motor assembly is to be fitted. The bearing block comprises two parts, a first part fixed to the stator and a second part fixed to the rotor. The bearing block is fixed to a central portion 253 of the wall of the stator 252 and also to a central portion 225 of the housing wall 220 of the rotor 240. The rotor 240 is thus rotationally fixed to the vehicle with which it is to be used via the bearing block 223 at the central portion 225 of the rotor 240 such that the axis of rotation of the rotor for each respective in-wheel electric motor is positioned between the front and rear of a respective crumple zone. This has an advantage in that a wheel rim and tyre can then be fixed to the rotor 240 at the central portion 225 using the normal wheel bolts to fix the wheel rim to the central portion of the rotor and consequently firmly onto the rotatable side of the bearing block 223. The wheel bolts may be fitted through the central portion 225 of the rotor through into the bearing block itself. With both the rotor 240 and the wheel being mounted to the bearing block 223 there is a one to one correspondence between the angle of rotation of the rotor and the wheel.

FIG. 2 shows an exploded view of the same assembly as FIG. 1 from the opposite side showing the stator 252 and rotor. The rotor 240 comprises the outer rotor wall 220 and circumferential wall 221 within which magnets 242 are circumferentially arranged. As previously described, the stator 252 is connected to the rotor 240 via the bearing block at the central portions of the rotor and stator walls.

A V shaped seal is provided between the circumferential wall 221 of the rotor and the outer edge of the stator.

The rotor also includes a set of magnets 227 for position sensing, otherwise known as commutation magnets, which in conjunction with sensors mounted on the stator allows for a rotor flux angle to be estimated. The rotor flux angle defines the positional relationship of the drive magnets to the coil windings. Alternatively, in place of a set of separate magnets the rotor may include a ring of magnetic material that has multiple poles that act as a set of separate magnets.

To allow the commutation magnets to be used to calculate a rotor flux angle, preferably each drive magnet has an associated commutation magnet, where the rotor flux angle is derived from the flux angle associated with the set of commutation magnets by calibrating the measured commutation magnet flux angle. To simplify the correlation between the commutation magnet flux angle and the rotor flux angle, preferably the set of commutation magnets has the same number of magnets or magnet pole pairs as the set of drive magnet pairs, where the commutation magnets and associated drive magnets are approximately radially aligned with each other. Accordingly, for the purposes of the present embodiment the set of commutation magnets has 32 magnet pairs, where each magnet pair is approximately radially aligned with a respective drive magnet pair.

A sensor, which in this embodiment is a Hall sensor, is mounted on the stator. The sensor is positioned so that as the rotor rotates each of the commutation magnets that form the commutation magnet ring respectively rotates past the sensor.

As the rotor rotates relative to the stator the commutation magnets correspondingly rotate past the sensor with the Hall sensor outputting an AC voltage signal, where the sensor outputs a complete voltage cycle of 360 electrical degrees for each magnet pair that passes the sensor.

For improve position detection, preferably the sensor include an associated second sensor placed 90 electrical degrees displaced from the first sensor.

Each in-wheel electric motor in this embodiment includes four coil sets with each coil set having three coil sub-sets that are coupled in a wye configuration to form a three phase sub-motor, resulting in the motor having four three phase sub-motors. A first control device is coupled to two coil sets with a second control device being coupled to the other coil sets, where each inverter in the respective control devices is arranged to control current in a respective coil set. However, although the present embodiment describes an electric motor having four coil sets (i.e. four sub motors) the motor may equally have one or more coil sets with associated control devices (i.e. a single motor or a motor having two or more sub motors). For example in a preferred embodiment the motor 40 includes eight coil sets with each coil set having three coil sub-sets that are coupled in a wye configuration to form a three phase sub-motor, resulting in the motor having eight three phase sub-motors.

1. A vehicle having a passenger compartment and a crumple zone, wherein the crumple zone has reduced impact resistance relative to the passenger compartment and is positioned forward of the passenger compartment, further comprising a first wheel arranged to be driven by a first drive source having a first axis of rotation for rotating the first wheel and a second wheel arranged to be driven by a second drive source having a second axis of rotation for rotating the second wheel, wherein the first wheel and the second wheel are transversely located on the vehicle relative to each other, wherein the first axis of the first drive source and the second axis of the second drive source are positioned longitudinally between the front and rear of the crumple zone.

2. A vehicle according to claim 1, wherein the first drive source is an in-wheel electric motor and the second drive source is an in-wheel electric motor.

3. A vehicle according to claim 2, wherein the in-wheel electric motor is coupled to the vehicle via a bearing, wherein the axis of the bearing is positioned between the front and rear of the crumple zone.

4. A vehicle having a passenger compartment and a crumple zone, wherein the crumple zone has reduced impact resistance relative to the passenger compartment and is positioned behind the passenger compartment, further comprising a first wheel arranged to be driven by a first drive source having a first axis of rotation for rotating the first wheel and a second wheel arranged to be driven by a second drive source having a second axis of rotation for rotating the second wheel, wherein the first wheel and the second wheel are transversely located on the vehicle relative to each other, wherein the first axis of the first drive source and the second axis of the second drive source are positioned longitudinally between the front and rear of the crumple zone.

5. A vehicle according to claim 4, wherein the first drive source is an in-wheel electric motor and the second drive source is an in-wheel electric motor.

6. A vehicle according to claim 5, wherein the in-wheel electric motor is coupled to the vehicle via a bearing, wherein the axis of the bearing is positioned between the front and rear of the crumple zone.
